(19) United States
(12) Patent Application Publication
(10) Pub. No.: US 2023/0003533 A1
(43) Pub. Date: Jan. 5, 2023

(54) FAST COLLISION FREE PATH GENERATION BY CONNECTING C-SLICES THROUGH CELL DECOMPOSITION

(71) Applicant: Motional AD LLC, Boston, MA (US)

(72) Inventors: Qianli Ma, Pittsburgh, PA (US); Sipu Ruan, Pittsburgh, PA (US); Shu-Kai Lin, Pittsburgh, PA (US); Shih-Yuan Liu, Arlington, MA (US)

(21) Appl. No.: 17/363,226

(22) Filed: Jun. 30, 2021

(51) Int. Cl. G01C 21/34

(52) U.S. Cl. CPC G01C 21/3407

(57) ABSTRACT

Among other things, techniques are described for collision free path generation by connecting C-slices through cell decomposition. An environment is sampled at discrete headings of a vehicle to generate a configuration space (C-space) with one or more C-slices. A first C-slice is decomposed into one or more cells that represent free space. A C-slice adjacency list is generated for the first C-slice. A super adjacency list is derived that connects vertices of interest across the one or more C-slices to form a super adjacency graph. In embodiments, Dubins path is used for connecting the vertices of interest both within and across C-slices to ensure the kinematic feasibility of all the searched paths. An optimal path is navigated, wherein the optimal path is a shortest path from a starting pose to a goal pose on the super adjacency graph.

### FIELD OF THE INVENTION

This description relates to collision free path generation by connecting C-slices through cell decomposition.

### BACKGROUND

Navigation of a vehicle from an initial location to a final destination often requires the vehicle's decision-making system to select a path from the initial location to the requested final destination. Various objects can be located between the initial location and the final destination. Possible paths are represented using a graph with a number of vertices and edges, and the decision making system of the vehicle selects paths according to any number of constraints. Objects impact the location of possible paths. Collision free paths are those paths that avoid vertices and edges that lie across or near objects. When a graph contains a large number of vertices and edges, planning a path can be time consuming as well as computational resource consuming.

### BRIEF DESCRIPTION OF THE DRAWINGS

FIG. 1 shows an example of an autonomous vehicle (AV) having autonomous capability.

FIG. 2 shows an example “cloud” computing environment.

FIG. 3 shows a computer system.

FIG. 4 shows an example architecture for an AV.

FIG. 5 shows an example of inputs and outputs that can be used by a perception system.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning system.

FIG. 10 shows a directed graph used in path planning.

FIG. 11 shows a block diagram of the inputs and outputs of a control system.

FIG. 12 shows a block diagram of the inputs, outputs, and components of a controller.

FIG. 13A is an illustration of a vehicle on a collision path.

FIG. 13B is an illustration of a vehicle navigating a collision free path.

FIG. 14 is a process flow diagram of a process that enables fast collision free path generation.

FIG. 15 is a process flow diagram of a process that enables cell decomposition and vertex connection.

FIG. 16 is an illustration of a C-space with a set of C-slices.

FIG. 17A is an illustration of a C-slice post processed by trapezoidal decomposition.

FIG. 17B is an illustration of a C-slice with adaptive vertex of interest insertion.

FIG. 18A is an illustration of a super adjacency graph using a brute force connection strategy.

FIG. 18B is an illustration of a super adjacency graph using a brute force beyond a ball connection strategy.

FIG. 18C is an illustration of a super adjacency graph using an adjacent cell, brute force adjacent slices connection strategy.

FIG. 18D is an illustration of a super adjacency graph using an adjacent cell, brute force inter-slice connection strategy.

FIG. 18E is an illustration of a super adjacency graph using a grid-like connection strategy.

FIG. 19 a process flow diagram of a process that enables fast collision free path generation by connecting C-slices through cell decomposition.

### DETAILED DESCRIPTION

In the following description, for the purposes of explanation, numerous specific details are set forth in order to provide a thorough understanding of the present disclosure. It will be apparent, however, that the present disclosure can be practiced without these specific details. In other instances, well-known structures and devices are shown in block diagram form in order to avoid unnecessarily obscuring the present disclosure.

In the drawings, specific arrangements or orderings of schematic elements, such as those representing devices, modules, systems, instruction blocks, and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. System Overview

3. AV Architecture

4. AV Inputs

5. Path Planning

6. AV Control

7. Obstacle Avoidance

8. C-Space Generation and Cell decomposition

9. Graph Generation and Search

10. Collision free path generation by connecting C-slices through cell decomposition

### General Overview

A vehicle can independently navigate through an environment from a starting pose to an ending pose. To successfully navigate through the environment, the environment is represented as a configuration space (C-space) with any number of objects, represented by C-obstacles within the C-space. The C-space is a three-dimensional space parameterized by latitude (e.g., x), longitude (e.g., y), and a heading (e.g., θ). The vehicle and objects are represented by convex polygons within the C-space. Each discrete heading corresponds to a slice (C-slice) of the C-space. Cell decomposition is performed on each C-slice and vertices of interest are generated by strategically inserting vertices at free cell boundaries based on, at least in part, a C-obstacle type, to obtain a C-slice adjacency list. A super adjacency list is derived from the set of C-slice adjacency lists. A super adjacency graph is derived for the C-space by connecting vertices of interest within the C-slice adjacency lists and across the C-slices according to transition and collision detection techniques.

Some of the advantages of these techniques include a high success rate in finding feasible paths with relatively short computation time. Discretizing the heading enables the representation of the vehicle and objects as convex polygons, which ultimately enables the cell decomposition with a reduced computational complexity when compared to vehicle and object representations in a higher-order space. Moreover, the derived adjacency lists require fewer vertices to generate collision free paths among many objects when compared to other algorithms, and a path computed via the present techniques is smoother in terms of an accumulation of curvatures.

### System Overview

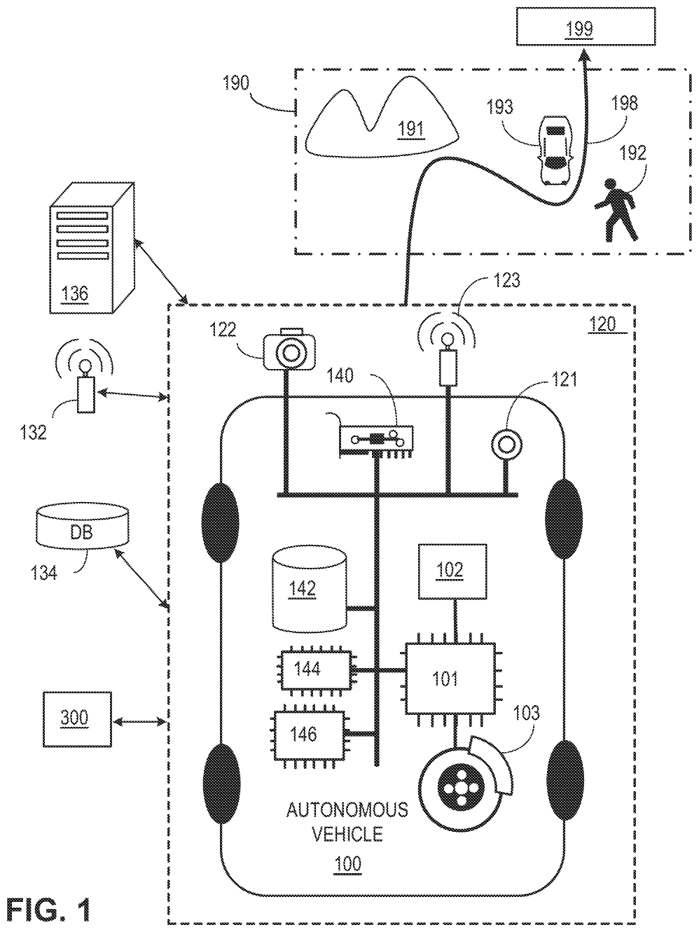

FIG. 1 shows an example of an AV 100 having autonomous capability.

As used herein, the term “autonomous capability” refers to a function, feature, or facility that enables a vehicle to be partially or fully operated without real-time human intervention, including without limitation fully AVs, highly AVs, and conditionally AVs.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pickup trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “over-the-air (OTA) update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

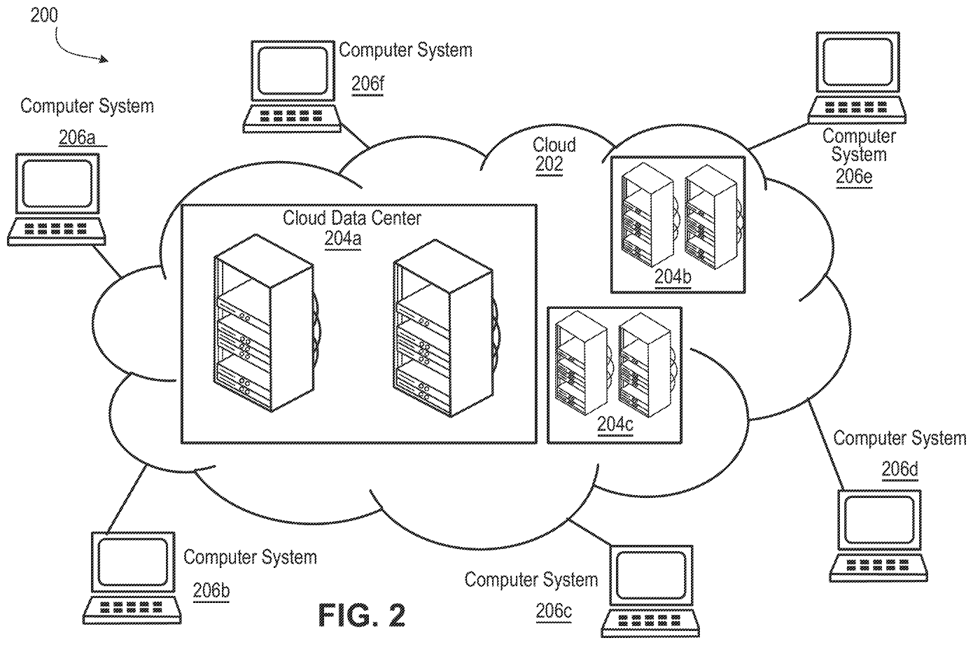

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to cloud computing environment 200 described below with respect to FIG. 2.

In general, this document describes technologies applicable to any vehicles that have one or more autonomous capabilities including fully AVs, highly AVs, and conditionally AVs, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially AVs and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems can automate certain vehicle operations (e.g., steering, braking, and using maps) under certain operating conditions based on processing of sensor inputs. The technologies described in this document can benefit vehicles in any levels, ranging from fully AVs to human-operated vehicles.

AVs have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

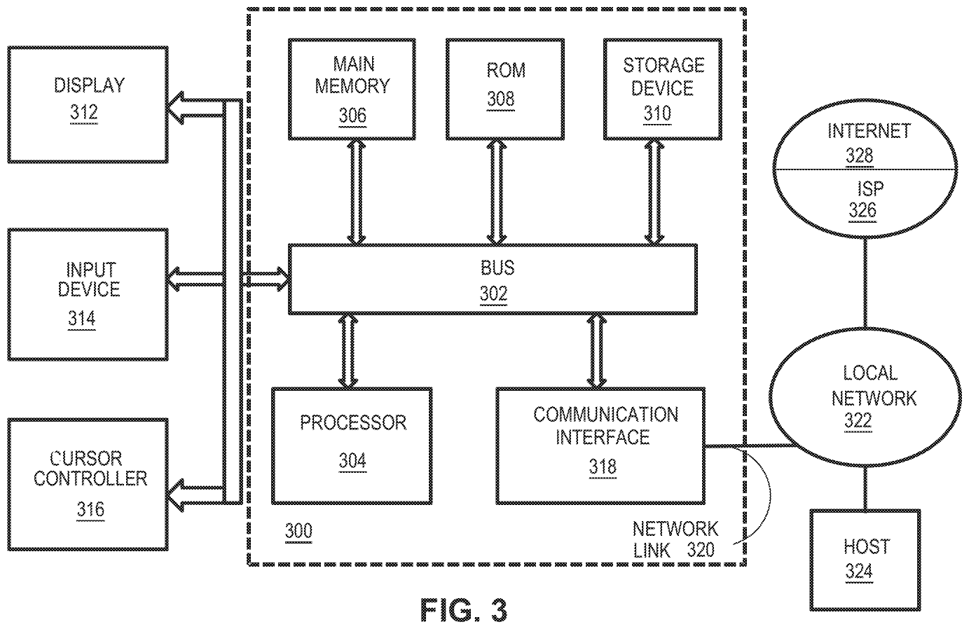

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, include instructions for a vehicle to start moving forward, stop moving forward, start moving backward, stop moving backward, accelerate, decelerate, perform a left turn, and perform a right turn. In an embodiment, computing processors 146 are similar to the processor 304 described below in reference to FIG. 3. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the vehicle 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among AVs.

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication devices 140 transmit data collected from sensors 121 or other data related to the operation of vehicle 100 to the remotely located database 134. In an embodiment, communication devices 140 transmit information that relates to teleoperations to the vehicle 100. In some embodiments, the vehicle 100 communicates with other remote (e.g., “cloud”) servers 136.

In an embodiment, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data can be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

In an embodiment, the AV system 120 includes computer peripherals 132 coupled to computer processors 146 for providing information and alerts to, and receiving input from, a user (e.g., an occupant or a remote user) of the vehicle 100. In an embodiment, peripherals 132 are similar to the display 312, input device 314, and cursor controller 316 discussed below in reference to FIG. 3. The coupling is wireless or wired. Any two or more of the interface devices can be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies one or more entities that are authorized to access the information. Examples of specified entities that are authorized to access information can include other AVs, third party AV systems, or any entity that could potentially access the information.

A privacy level of a passenger can be specified at one or more levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 shows an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers are physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. In some implementations, servers in zones, rooms, racks, and/or rows are arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, AVs (including, cars, drones, shuttles, trains, buses, etc.) and consumer electronics. In an embodiment, the computing systems 206a-f are implemented in or as a part of other systems.

FIG. 3 shows a computer system 300. In an implementation, the computer system 300 is a special purpose computing device. The special-purpose computing device is hard-wired to perform the techniques or includes digital electronic devices such as one or more application-specific integrated circuits (ASICs) or field programmable gate arrays (FPGAs) that are persistently programmed to perform the techniques, or can include one or more general purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 300 includes a bus 302 or other communication mechanism for communicating information, and a processor 304 coupled with a bus 302 for processing information. The processor 304 is, for example, a general-purpose microprocessor. The computer system 300 also includes a main memory 306, such as a random-access memory (RAM) or other dynamic storage device, coupled to the bus 302 for storing information and instructions to be executed by processor 304. In one implementation, the main memory 306 is used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, solid-state drive, or three-dimensional cross point memory is provided and coupled to the bus 302 for storing information and instructions.

In an embodiment, the computer system 300 is coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions are read into the main memory 306 from another storage medium, such as the storage device 310. Execution of the sequences of instructions contained in the main memory 306 causes the processor 304 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

In an embodiment, various forms of media are involved in carrying one or more sequences of one or more instructions to the processor 304 for execution. For example, the instructions are initially carried on a magnetic disk or solid-state drive of a remote computer. The remote computer loads the instructions into its dynamic memory and send the instructions over a telephone line using a modem. A modem local to the computer system 300 receives the data on the telephone line and use an infrared transmitter to convert the data to an infrared signal. An infrared detector receives the data carried in the infrared signal and appropriate circuitry places the data on the bus 302. The bus 302 carries the data to the main memory 306, from which processor 304 retrieves and executes the instructions. The instructions received by the main memory 306 can optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 is an integrated service digital network (ISDN) card, cable modem, satellite modem, or a modem to provide a data communication connection to a corresponding type of telephone line. As another example, the communication interface 318 is a local area network (LAN) card to provide a data communication connection to a compatible LAN. In some implementations, wireless links are also implemented. In any such implementation, the communication interface 318 sends and receives electrical, electromagnetic, or optical signals that carry digital data streams representing various types of information.

The network link 320 typically provides data communication through one or more networks to other data devices. For example, the network link 320 provides a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 contains the cloud 202 or a part of the cloud 202 described above.

The computer system 300 sends messages and receives data, including program code, through the network(s), the network link 320, and the communication interface 318. In an embodiment, the computer system 300 receives code for processing. The received code is executed by the processor 304 as it is received, and/or stored in storage device 310, or other non-volatile storage for later execution.

### AV Architecture

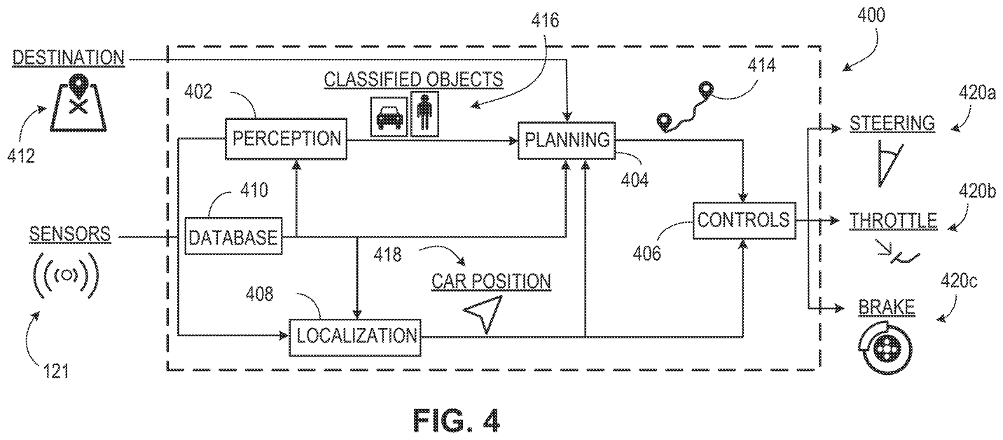

FIG. 4 shows an example architecture 400 for an AV (e.g., the vehicle 100 shown in FIG. 1). The architecture 400 includes a perception system 402 (sometimes referred to as a perception circuit), a planning system 404 (sometimes referred to as a planning circuit), a control system 406 (sometimes referred to as a control circuit), a localization system 408 (sometimes referred to as a localization circuit), and a database system 410 (sometimes referred to as a database circuit). Each system plays a role in the operation of the vehicle 100. Together, the systems 402, 404, 406, 408, and 410 can be part of the AV system 120 shown in FIG. 1. In some embodiments, any of the systems 402, 404, 406, 408, and 410 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the systems 402, 404, 406, 408, and 410 is sometimes referred to as a processing circuit (e.g., computer hardware, computer software, or a combination of the two). A combination of any or all of the systems 402, 404, 406, 408, and 410 is also an example of a processing circuit.

In use, the planning system 404 receives data representing a destination 412 and determines data representing a trajectory 414 (sometimes referred to as a route) that can be traveled by the vehicle 100 to reach (e.g., arrive at) the destination 412. In order for the planning system 404 to determine the data representing the trajectory 414, the planning system 404 receives data from the perception system 402, the localization system 408, and the database system 410.

The perception system 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning system 404.

The planning system 404 also receives data representing the AV position 418 from the localization system 408. The localization system 408 determines the AV position by using data from the sensors 121 and data from the database system 410 (e.g., a geographic data) to calculate a position. For example, the localization system 408 uses data from a GNSS (Global Navigation Satellite System) sensor and geographic data to calculate a longitude and latitude of the AV. In an embodiment, data used by the localization system 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control system 406 receives the data representing the trajectory 414 and the data representing the AV position 418 and operates the control functions 420a-c (e.g., steering, throttling, braking, ignition) of the AV in a manner that will cause the vehicle 100 to travel the trajectory 414 to the destination 412. For example, if the trajectory 414 includes a left turn, the control system 406 will operate the control functions 420a-c in a manner such that the steering angle of the steering function will cause the vehicle 100 to turn left and the throttling and braking will cause the vehicle 100 to pause and wait for passing pedestrians or vehicles before the turn is made.

### AV Inputs

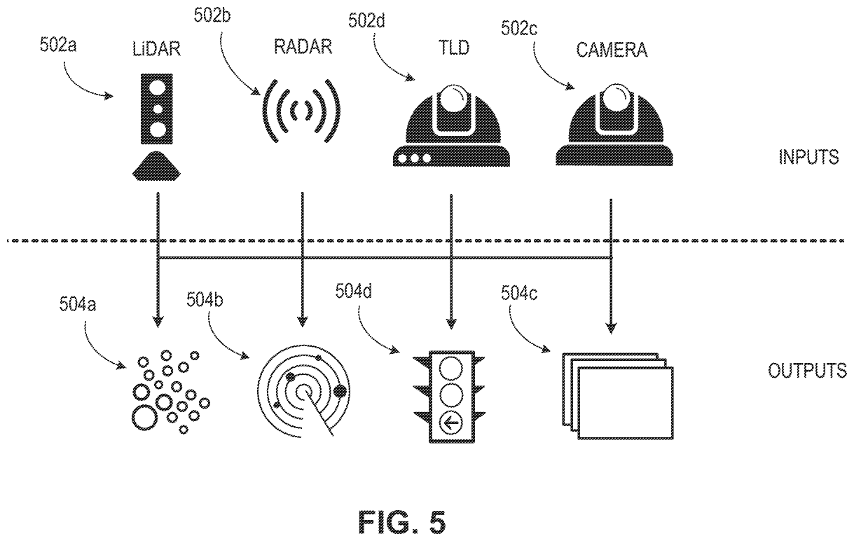

FIG. 5 shows an example of inputs 502a-d (e.g., sensors 121 shown in FIG. 1) and outputs 504a-d (e.g., sensor data) that is used by the perception system 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data is collections of 3D or 2D points (also known as point clouds) that are used to construct a representation of the environment 190.

Another input 502b is a RADAR system. RADAR is a technology that uses radio waves to obtain data about nearby physical objects. RADARs can obtain data about objects not within the line of sight of a LiDAR system. A RADAR system produces RADAR data as output 504b. For example, RADAR data are one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In some embodiments, the camera system is configured to “see” objects far, e.g., up to a kilometer or more ahead of the AV. Accordingly, in some embodiments, the camera system has features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from a system incorporating a camera in that a TLD system uses a camera with a wide field of view (e.g., using a wide-angle lens or a fish-eye lens) in order to obtain information about as many physical objects providing visual navigation information as possible, so that the vehicle 100 has access to all relevant navigation information provided by these objects. For example, the viewing angle of the TLD system is about 120 degrees or more.

In some embodiments, outputs 504a-d are combined using a sensor fusion technique. Thus, either the individual outputs 504a-d are provided to other systems of the vehicle 100 (e.g., provided to a planning system 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

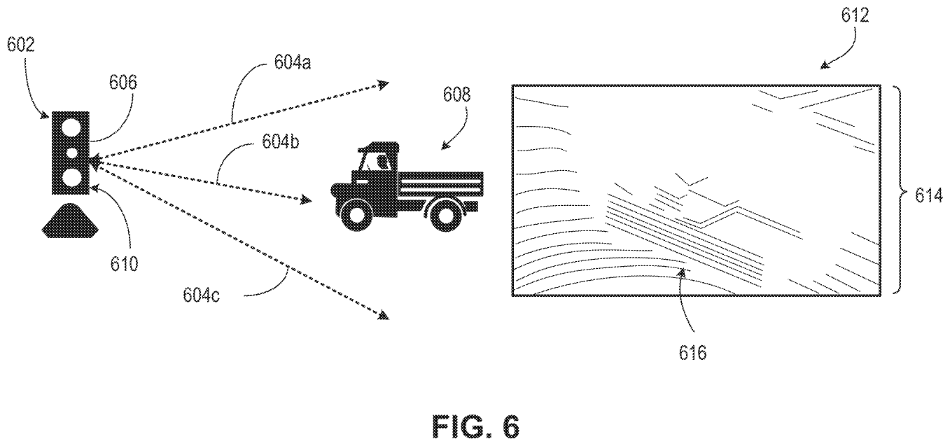

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. In an embodiment, one or more data processing systems associated with the LiDAR system generates an image 612 representing the field of view 614 of the LiDAR system. The image 612 includes information that represents the boundaries 616 of a physical object 608. In this way, the image 612 is used to determine the boundaries 616 of one or more physical objects near an AV.

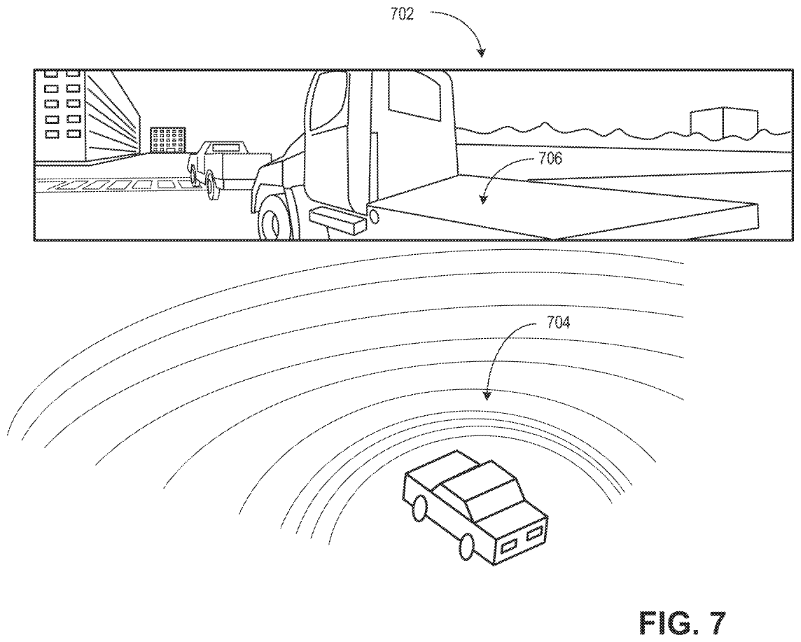

FIG. 7 shows the LiDAR system 602 in operation. In the scenario shown in this figure, the vehicle 100 receives both camera system output 504c in the form of an image 702 and LiDAR system output 504a in the form of LiDAR data points 704. In use, the data processing systems of the vehicle 100 compares the image 702 to the data points 704. In particular, a physical object 706 identified in the image 702 is also identified among the data points 704. In this way, the vehicle 100 perceives the boundaries of the physical object based on the contour and density of the data points 704.

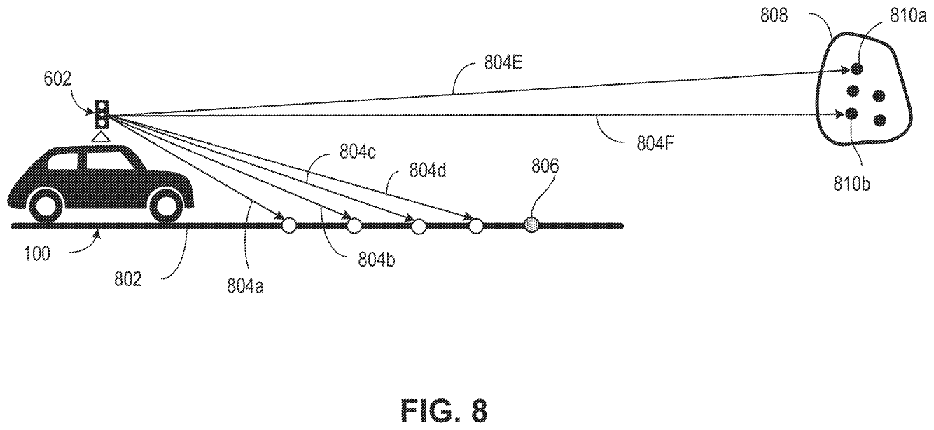

FIG. 8 shows the operation of the LiDAR system 602 in additional detail. As described above, the vehicle 100 detects the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the vehicle 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the vehicle 100 can determine that the object 808 is present.

### Path Planning

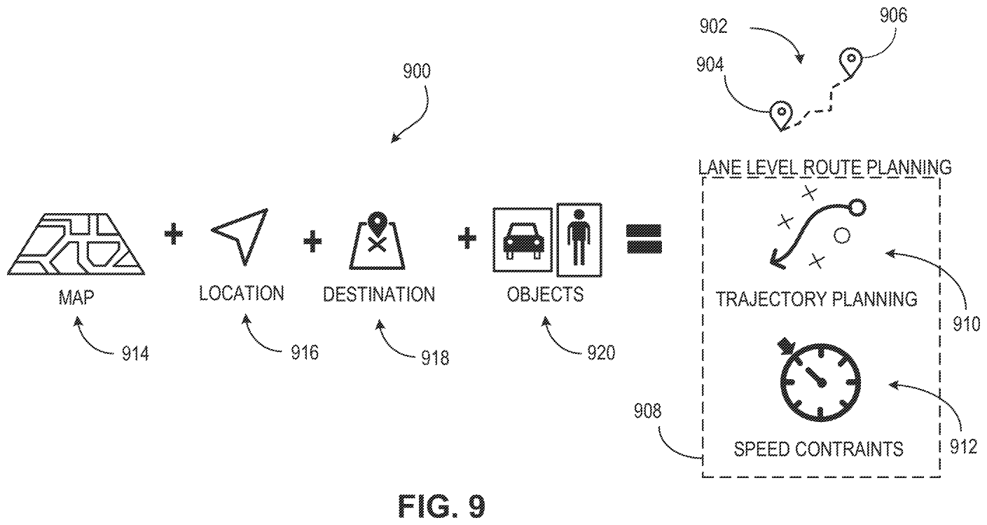

FIG. 9 shows a block diagram 900 of the relationships between inputs and outputs of a planning system 404 (e.g., as shown in FIG. 4). In general, the output of a planning system 404 is a route 902 from a start point 904 (e.g., source location or initial location), and an end point 906 (e.g., destination or final location). The route 902 is typically defined by one or more segments. For example, a segment is a distance to be traveled over at least a portion of a street, road, highway, driveway, or other physical area appropriate for automobile travel. In some examples, e.g., if the vehicle 100 is an off-road capable vehicle such as a four-wheel-drive (4WD) or all-wheel-drive (AWD) car, SUV, pick-up truck, or the like, the route 902 includes “off-road” segments such as unpaved paths or open fields.

In addition to route 902, a planning system also outputs lane-level route planning data 908. The lane-level route planning data 908 is used to traverse segments of the route 902 based on conditions of the segment at a particular time. For example, if the route 902 includes a multi-lane highway, the lane-level route planning data 908 includes trajectory planning data 910 that the vehicle 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 908 includes speed constraints 912 specific to a segment of the route 902. For example, if the segment includes pedestrians or un-expected traffic, the speed constraints 912 may limit the vehicle 100 to a travel speed slower than an expected speed, e.g., a speed based on speed limit data for the segment.

In an embodiment, the inputs to the planning system 404 includes database data 914 (e.g., from the database system 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception system 402 as shown in FIG. 4). In some embodiments, the database data 914 includes rules used in planning. Rules are specified using a formal language, e.g., using Boolean logic. In any given situation encountered by the vehicle 100, at least some of the rules will apply to the situation. A rule applies to a given situation if the rule has conditions that are met based on information available to the vehicle 100, e.g., information about the surrounding environment. Rules can have priority. For example, a rule that says, “if the road is a freeway, move to the leftmost lane” can have a lower priority than “if the exit is approaching within a mile, move to the rightmost lane.”

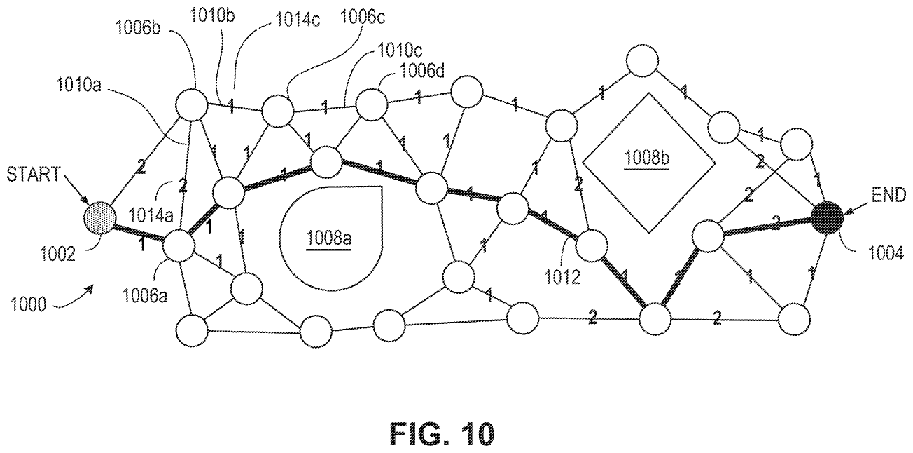

FIG. 10 shows a directed graph 1000 used in path planning, e.g., by the planning system 404 (FIG. 4). In general, a directed graph 1000 like the one shown in FIG. 10 is used to determine a path between any start point 1002 and end point 1004. In real-world terms, the distance separating the start point 1002 and end point 1004 may be relatively large (e.g, in two different metropolitan areas) or may be relatively small (e.g., two intersections abutting a city block or two lanes of a multi-lane road).

In an embodiment, the directed graph 1000 has nodes 1006a-d representing different locations between the start point 1002 and the end point 1004 that could be occupied by a vehicle 100. In some examples, e.g., when the start point 1002 and end point 1004 represent different metropolitan areas, the nodes 1006a-d represent segments of roads. In some examples, e.g., when the start point 1002 and the end point 1004 represent different locations on the same road, the nodes 1006a-d represent different positions on that road. In this way, the directed graph 1000 includes information at varying levels of granularity. In an embodiment, a directed graph having high granularity is also a subgraph of another directed graph having a larger scale. For example, a directed graph in which the start point 1002 and the end point 1004 are far away (e.g., many miles apart) has most of its information at a low granularity and is based on stored data, but also includes some high granularity information for the portion of the graph that represents physical locations in the field of view of the vehicle 100.

The nodes 1006a-d are distinct from objects 1008a-b which cannot overlap with a node. In an embodiment, when granularity is low, the objects 1008a-b represent regions that cannot be traversed by automobile, e.g., areas that have no streets or roads. When granularity is high, the objects 1008a-b represent physical objects in the field of view of the vehicle 100, e.g., other automobiles, pedestrians, or other entities with which the vehicle 100 cannot share physical space. In an embodiment, some or all of the objects 1008a-b are a static objects (e.g., an object that does not change position such as a street lamp or utility pole) or dynamic objects (e.g., an object that is capable of changing position such as a pedestrian or other car).

The nodes 1006a-d are connected by edges 1010a-c. If two nodes 1006a-b are connected by an edge 1010a, it is possible for a vehicle 100 to travel between one node 1006a and the other node 1006b, e.g., without having to travel to an intermediate node before arriving at the other node 1006b. (When we refer to a vehicle 100 traveling between nodes, we mean that the vehicle 100 travels between the two physical positions represented by the respective nodes.) The edges 1010a-c are often bidirectional, in the sense that a vehicle 100 travels from a first node to a second node, or from the second node to the first node. In an embodiment, edges 1010a-c are unidirectional, in the sense that a vehicle 100 can travel from a first node to a second node, however the vehicle 100 cannot travel from the second node to the first node. Edges 1010a-c are unidirectional when they represent, for example, one-way streets, individual lanes of a street, road, or highway, or other features that can only be traversed in one direction due to legal or physical constraints.

In an embodiment, the planning system 404 uses the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the vehicle 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning system 404 identifies a path 1012 between the start point 1002 and end point 1004, the planning system 404 typically chooses a path optimized for cost, e.g., the path that has the least total cost when the individual costs of the edges are added together.

### AV Control

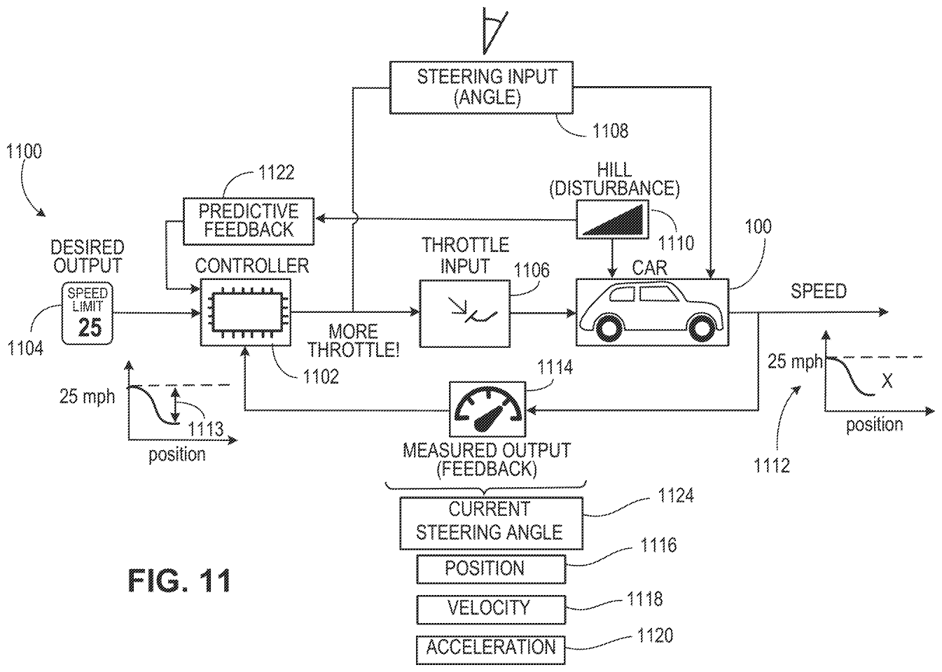

FIG. 11 shows a block diagram 1100 of the inputs and outputs of a control system 406 (e.g., as shown in FIG. 4). A control system operates in accordance with a controller 1102 which includes, for example, one or more processors (e.g., one or more computer processors such as microprocessors or microcontrollers or both) similar to processor 304, short-term and/or long-term data storage (e.g., memory random-access memory or flash memory or both) similar to main memory 306, ROM 308, and storage device 310, and instructions stored in memory that carry out operations of the controller 1102 when the instructions are executed (e.g., by the one or more processors).

In an embodiment, the controller 1102 receives data representing a desired output 1104. The desired output 1104 typically includes a velocity, e.g., a speed and a heading. The desired output 1104 can be based on, for example, data received from a planning system 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of a vehicle 100, e.g., by engaging the steering pedal, or engaging another throttle control, to achieve the desired output 1104. In some examples, the throttle input 1106 also includes data usable to engage the brake (e.g., deceleration control) of the vehicle 100. The steering input 1108 represents a steering angle, e.g., the angle at which the steering control (e.g., steering wheel, steering angle actuator, or other functionality for controlling steering angle) of the AV should be positioned to achieve the desired output 1104.

In an embodiment, the controller 1102 receives feedback that is used in adjusting the inputs provided to the throttle and steering. For example, if the vehicle 100 encounters a disturbance 1110, such as a hill, the measured speed 1112 of the vehicle 100 is lowered below the desired output speed. In an embodiment, any measured output 1114 is provided to the controller 1102 so that the necessary adjustments are performed, e.g., based on the differential 1113 between the measured speed and desired output. The measured output 1114 includes a measured position 1116, a measured velocity 1118 (including speed and heading), a measured acceleration 1120, and other outputs measurable by sensors of the vehicle 100. In embodiments, a current steering angle 1124 is provided as a measured output.

In an embodiment, information about the disturbance 1110 is detected in advance, e.g., by a sensor such as a camera or LiDAR sensor, and provided to a predictive feedback system 1122. The predictive feedback system 1122 then provides information to the controller 1102 that the controller 1102 can use to adjust accordingly. For example, if the sensors of the vehicle 100 detect (“see”) a hill, this information can be used by the controller 1102 to prepare to engage the throttle at the appropriate time to avoid significant deceleration.

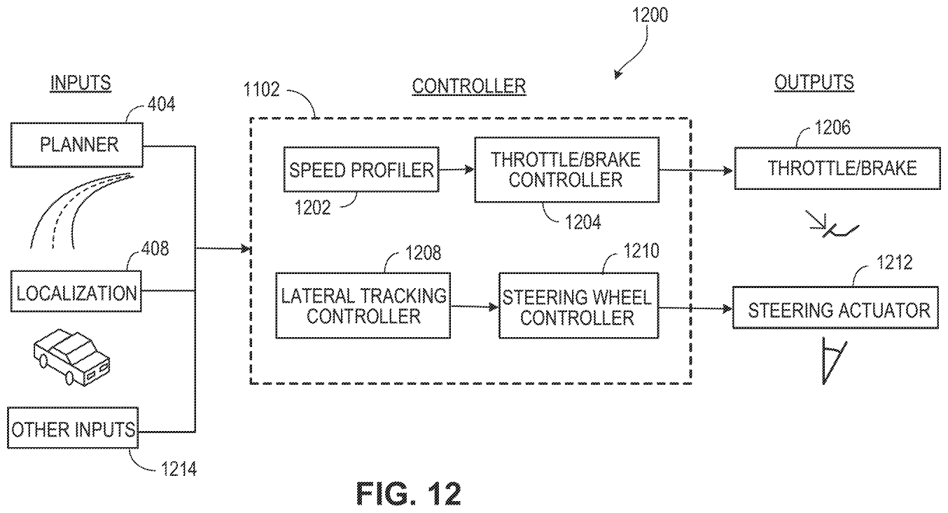

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 instructs the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 instructs the steering controller 1210 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning system 404 provides information used by the controller 1102, for example, to choose a heading when the vehicle 100 begins operation and to determine which road segment to traverse when the vehicle 100 reaches an intersection. A localization system 408 provides information to the controller 1102 describing the current location of the vehicle 100, for example, so that the controller 1102 can determine if the vehicle 100 is at a location expected based on the manner in which the throttle/brake 1206 and steering angle actuator 1212 are being controlled. In an embodiment, the controller 1102 receives information from other inputs 1214, e.g., information received from databases, computer networks, etc.

### Obstacle Avoidance

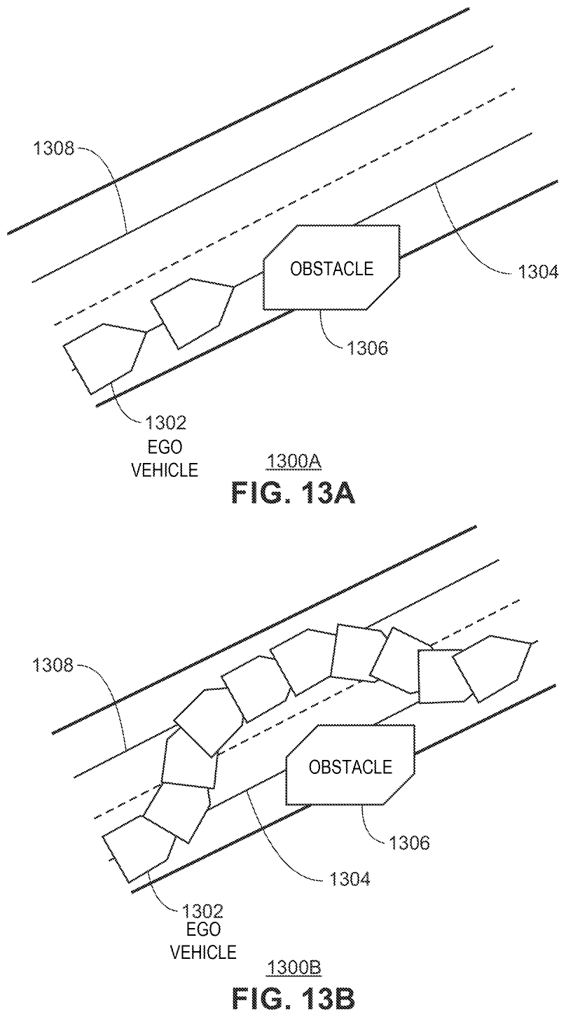

FIG. 13A is an illustration of a vehicle on a collision path 1300A. The vehicle 1302 (e.g., vehicle 100 of FIG. 1) may be an autonomous vehicle and is illustrated as traveling along a path 1304. For purposes of description, the path is drawn along the center of a lane of traffic. However, the path can occur along any physical area that can be traversed by a vehicle, can correspond to a named thoroughfare (e.g., city street, interstate freeway, etc.) or can correspond to an unnamed thoroughfare (e.g., a driveway in a house or office building, a section of a parking lot, a section of a vacant lot, a dirt path in a rural area, etc.). Thus, the illustrated lanes of traffic are for explanation and should not be viewed as limiting.

In the example of FIG. 13A, a continuous route along the path 1304 is infeasible due to the location of an object 1306. The object 1306 (e.g., natural obstructions 191, vehicles 193, pedestrians 192, cyclists, and other obstacles of FIG. 1) is detected by, for example, a perception circuit 402 as illustrated in FIG. 4. The path 1304 is a blocked path due to the location of object 1306. A collision free path 1308 is also illustrated. In the example of FIG. 13A, in a scenario where the vehicle 1302 continues along the path 1304, the vehicle 1302 will collide with the object 1306.

FIG. 13B is an illustration of a vehicle navigating a collision free path 1300B. The vehicle 1302 is illustrated as avoiding a collision with the object 1306 by traveling from the path 1304 to the path 1308 to avoid the object 1306. Once past a possibility of collision with the object 1306, the vehicle 1302 returns to the path 1304, which is clear beyond the object 1306. The vehicle can also remain on path 1308, which is also clear.

Generally, the paths 1304 and 1308 are derived from a graph, such as the directed graph 1000 of FIG. 10. In an embodiment, a graph representing collision free paths through a space is generated within a configuration space (C-space). The C-space is a three-dimensional space parameterized by latitude (e.g., x), longitude (e.g., y), and a heading (e.g., 0). The continuous C-space can be decomposed into a sequence of C-slices where a discrete heading corresponds to a slice (C-slice) of the C-space. Accordingly, the C-space decomposed into the set of C-slices is discrete in that the values of the heading are independent and at a predetermined resolution. In an embodiment, each discrete heading value represents a direction in which the vehicle is pointing, typically represented by an angle. For example, the heading value is an angular value within a field of view of one or more sensors, such as sensors 121 of FIG. 1. Objects (e.g., natural obstructions 191, vehicles 193, pedestrians 192, cyclists, and other obstacles of FIG. 1) are represented as C-obstacles on each C-slice.

### C-Space Generation and Cell Decomposition

To quickly and efficiently determine a collision free path around one or more objects, the present techniques enable collision free path generation by connecting C-slices through cell decomposition. In embodiments, cell decomposition is performed to generate collision free paths among objects. In particular, trapezoidal decomposition is used to generate a number of collision free spaces within each C-slice corresponding to the multiple predetermined headings of a vehicle.

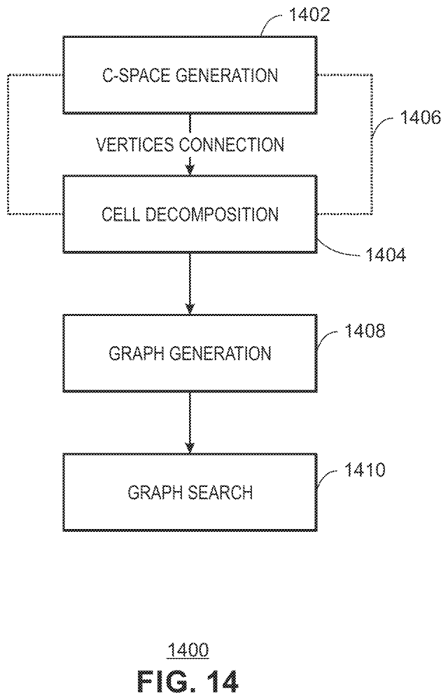

FIG. 14 is a flow diagram of a process 1400 that enables fast collision free path generation. A collision free path is a path that avoids collisions with detected objects. Objects are detected using one or more sensors (e.g., sensors 121 of FIG. 1) such as radar, LiDAR (e.g., LiDAR 123 of FIG. 1), or camera (e.g., cameras 122 of FIG. 1). The sensor data (e.g., output 504a-504d of FIG. 5) is obtained to calculate the poses and geometric shapes of all objects detected in the environment (e.g., environment 190 of FIG. 1).

At block 1402 a C-space is generated. To generate the C-space, the vehicle and objects are represented as convex polygons. Additionally, a start pose and an end pose are specified by the current and goal poses of the vehicle. Minkowski sums are computed between the vehicle and all detected objects. Representing the vehicle and the detected objects as convex polygons enables the calculation of the Minkowski sums as described below. In particular, Minkowski sums between the vehicle and all detected objects yields the C-space of the vehicle. The C-space consists of a number of C-slices, with each C-slice corresponding to a heading of the vehicle. Objects are represented in each C-slice as C-obstacles.

At block 1404, cell decomposition is performed for each C-slice. During cell decomposition, C-obstacle vertices are used to decompose each C-slice into a number of cells. Each cell of a C-slice represents free space that the vehicle can occupy. Discretizing the heading to obtain a number of C-slices and representing the vehicle and objects as convex polygons ultimately enables cell decomposition with a reduced computational complexity when compared to vehicle and obstacle representations in a higher-order space

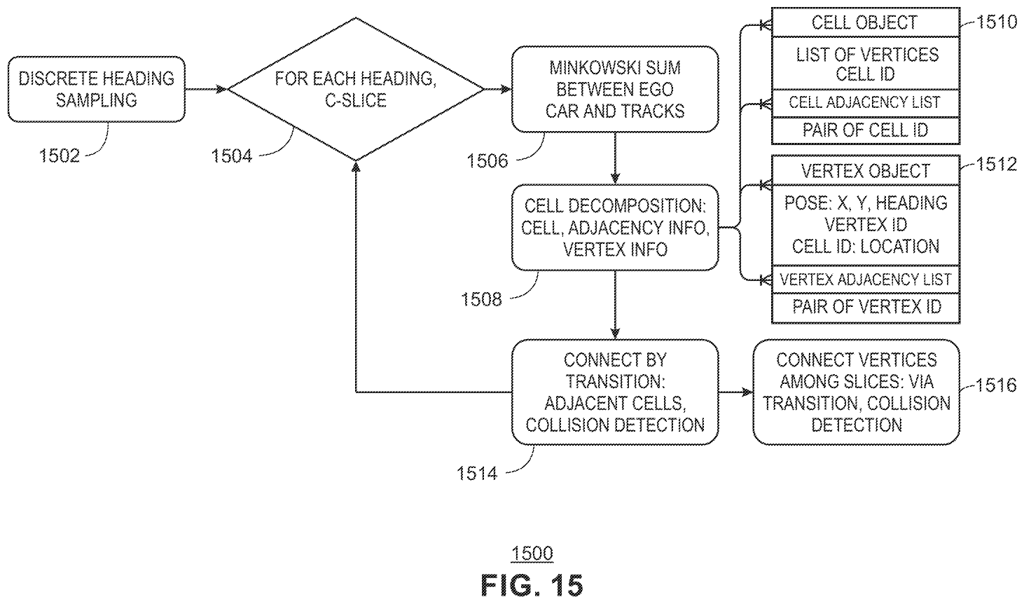

In FIG. 14, block 1406 represents vertex connection. Generally, during C-space generation at block 1402 vertices are generated and connected to define the C-obstacles. During cell decomposition at block 1404, vertices of interest are inserted at strategic points within the free space of each C-slice. In an embodiment, vertices of interest are inserted along cell boundaries according to the C-obstacle type to obtain a C-slice adjacency list. The C-slice adjacency lists for all C-slices in a C-space forms a set of C-slice adjacency lists for the C-space. Cell decomposition and vertex connection are further described below with respect to FIG. 15.

At block 1408, graph generation is performed. During graph generation, a super adjacency list is derived from the set of C-slice adjacency lists. The super adjacency list is derived by connecting vertices of interest across the C-slice adjacency lists according to collision detection techniques. In an embodiment, the C-slice adjacency list is mapped to a C-slice adjacency graph that connects vertices of interest within each C-slice. The super adjacency list is mapped to a super adjacency graph for the entire C-space that connects vertices of interest across all C-slices. The derived adjacency lists require fewer vertices to generate collision free paths among many obstacles compared to other algorithms, and a path computed via the present techniques is smoother in terms of accumulation of curvatures. At block 1410, a graph search is performed. The graph search enables the generation of collision free paths through the environment.

The process flow diagram of FIG. 14 is not intended to indicate that the blocks of the example process 1400 are to be executed in any order, or that all of the blocks are to be included in every case. Further, any number of additional blocks not shown may be included within the example process 1400, depending on the details of the specific implementation. In some examples, the vertex connections may include adaptive vertex connection, such that insertion locations for the vertices are dependent on the type of C-obstacle, the location of the C-obstacle with respect to other C-obstacles, and the like.

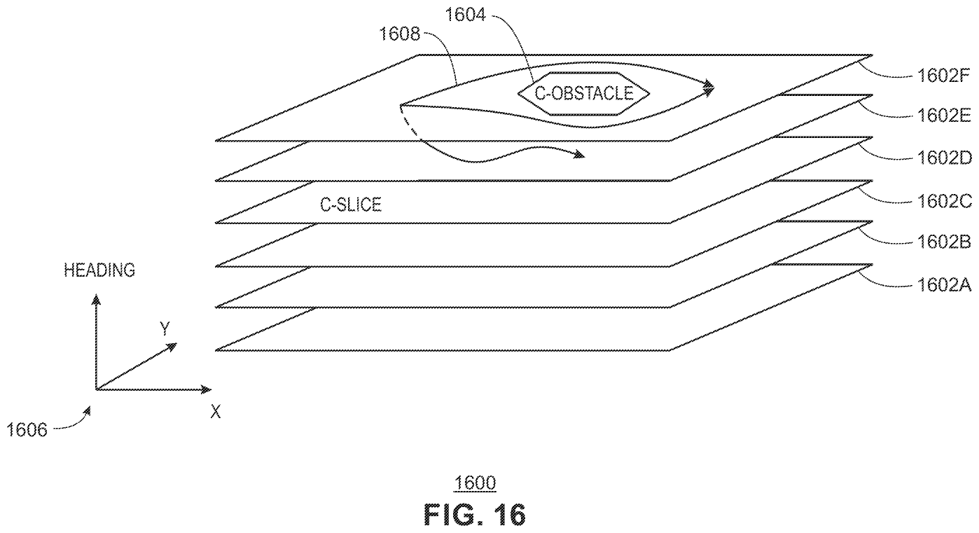

FIG. 15 is a process flow diagram of a process 1500 that enables cell decomposition and vertex connection. At block 1502, one or more headings within a field of view (e.g., field of view 614 of FIG. 6) of a vehicle are sampled to generate the C-space. In an embodiment, headings of the vehicle are uniformly sampled. The heading is expressed as an angle within a field of view of a perception system. For example, a perception system 402 (FIG. 4) samples at multiple headings to capture sensor data for each heading in the x-y domain. The sensor data (e.g., output 504a, output 504b, output 504c, and output 504d of FIG. 5) is processed to identify nearby physical objects using one or more sensors 121 (FIG. 1). In an embodiment, the objects are identified in a Euclidean space. Sampling along the discrete heading values generates a continuous x-y space for each heading value and enables the creation of a C-space as a continuous three dimensional (3D) model. FIG. 16 is an illustration of the continuous 3D model with a number of C-slices.

FIG. 16 is an illustration of a C-space 1600 with a set of C-slices 1602. As illustrated, an observed environment (e.g., environment 190 of FIG. 1) is mapped to each of C-slice 1602A, C-slice 1602B, C-slice 1602C, C-slice 1602D, C-slice 1602E, and C-slice 1602F. Each C-slice corresponds to a heading of a vehicle. One or more C-obstacles 1604 are computed for each C-slice 1602 based on the location of detected objects at the heading for each C-slice. The C-space 1600 is a three-dimensional space that is continuous in the x-y planes, identified according to the x, y, 0 coordinates 1606. A collision free path 1608 is generated across C-slices via a super adjacency list as described below.

Referring again to FIG. 15, at block 1504, an iterative process for C-obstacle generation and cell decomposition for each C-slice is initiated. In an embodiment, the field of view of a sensor is divided into a predetermined number of C-slices. In an embodiment, the C-slices are evenly spaced throughout the field of view. For example, consider a full 360° field of view in a global reference frame. In the example of FIG. 16, the number of C-slices is six. Thus, the C-slices correspond to six heading values, each spaced 30° apart to uniformly sample the environment across 180° of the entire field of view. In an environment with a large number of detected objects, a finer level of sampling may be needed to accurately detect objects and generate C-obstacles. For example, increasing the number of C-slices to eleven, each spaced 15° apart, defines a C-space with a finer resolution.

A general assumption when computing the Minkowski sum between two geometric shapes is that the orientations are fixed, and in the context of C-slice generation this means that the headings of both the ego vehicle and the other object (e.g., actor vehicle) will be fixed. When generating multiple C-slices, the number of predetermined headings of the ego vehicle may vary with the heading of the actor vehicle fixed. In an example, the resolution of the headings is pi/20, to obtain 10 C-slices within the field of view of the AV. For ease of description, a particular number of predetermined headings within a certain field of view is described. However, the number of predetermined headings, the resultant number of C-slices, and the field of view of the vehicle may vary and should not be viewed as limiting. Further, in an embodiment, C-slices can be placed at a higher resolution in areas of the field of view where a high number of objects are detected, while being placed at a low resolution in areas of the field of view where there are relatively few or no objects.

At block 1506, for a current C-slice, a Minkowski sum is calculated between the vehicle and the detected objects. Calculating the Minkowski sum for the vehicle and all detected objects generates C-obstacles for each C-slice. Generally, the Minkowski sum calculates an offset that shifts the edges of the polygons that represent the detected objects by a certain distance. In particular, the Minkowski sum identifies a set of coordinates for which one polygon overlaps another polygon. By assuming the polygons are convex, the computational complexity of computing the Minkowski sum is reduced. To compute the Minkowski sum the smallest convex set that contains the vehicle and the smallest convex set that contains the objects are computed. In an example, this is the respective polygons for each of the vehicles and detected objects. Normals (e.g., a theoretical line extending from an edge of the polygon) for the edges of the convex polygons are drawn. The normals are drawn outward for the detected objects and inward for the vehicle. The normals are then sorted in an increasing order with respect to their angles. A first point in the Minkowski sum is arbitrarily chosen as a point where a centroid of the vehicle lies at one of the vertex-vertex contacts of the obstacle and vehicle. The Minkowski sum is generated by adding each edge in the order specified by the normals. A significant observation is that every edge of the Minkowski sum polygon is a translated edge from either a detected object or the vehicle convex polygon. After the Minkowski sum has been calculated for each detected object, the detected objects are drawn in the respective C-slice as C-obstacles. In an embodiment, the vehicle is represented in each C-slice as a point that moves through the C-space. By fixing the heading of the vehicle at various values throughout the environment, multiple C-slices are generated with the same object represented as a C-obstacle in each slice with different shapes as a result of the Minkowski sum operation.

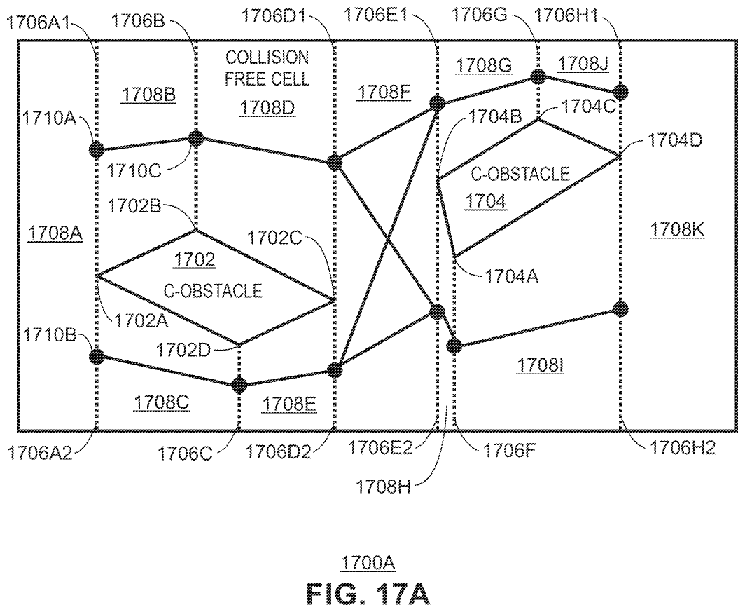

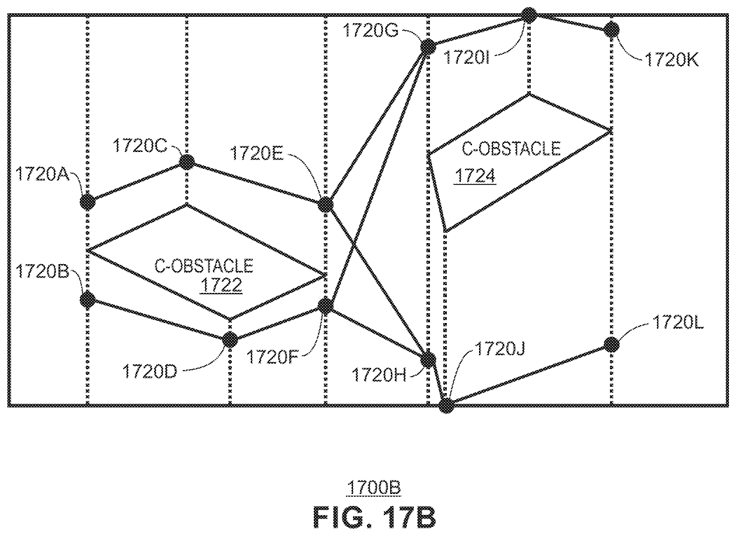

At block 1508, cell decomposition is performed for the C-slice. During cell decomposition, C-obstacle vertices are used to decompose the C-slice into a number of cells that represent the free space within the C-space. As used herein, the free space is a portion of the C-slice where no C-obstacles are drawn. The free space of the C-slice corresponds to areas of the environment where no objects are detected. Cell decomposition creates a number of cell boundary lines within a C-slice based on the C-obstacle location. For a current C-slice, trapezoidal cell decomposition is performed to break down one C-slice of the C-space into several trapezoidal cells. FIG. 17A is an illustration of C-slice 1700A with a number of cells.

In the C-slice 1700A, a C-obstacle 1702 and a C-obstacle 1704 are illustrated. The C-obstacles 1702 and 1704 are derived by calculating Minkowski sums as described above. To generate the cells of the C-slice, boundary lines 1706 are drawn from each vertex of a C-obstacle to a border of the C-slice. The boundary lines include boundary lines 1706A1, 1706A2, 1706B, 1706C, 1706D1, 1706D2, 1706E1, 1706E2, 1706F, 1706G, 1706H1, and 1706H2. The border of the C-slice is the end of data for the C-slice. A C-obstacle vertex is a point where two edges of the C-obstacle convex polygon meet. The C-obstacle 1702 has C-obstacle vertices 1702A, 1702B, 1702C and 1702D. The C-obstacle 1704 has C-obstacle vertices 1704A, 1704B, 1704C and 1704D.

Cell decomposition for each C-slice ensures that any path within a cell is obstacle free. In an embodiment, the cell decomposition is exact cell decomposition. In exact cell decomposition, at each vertex of a C-obstacle on the respective C-slice, a boundary line is extended from the vertex of the C-obstacle until a border of the C-space or another C-obstacle is reached. In the example of FIG. 17A, boundary lines 1706 are illustrated using dashed lines that extend from a respective vertex of C-obstacles 1702 and 1704. The dashed lines create a number of cells 1708A, 1708B, 1708C, 1708D, 1708E, 1708F, 1708G, 1708H, 1708I, 1708J, and 1708K. In an embodiment, cell decomposition is approximate. In approximate cell decomposition, beginning with the entire C-slice as a cell, the cells are recursively subdivided until a cell lies completely within free space or completely within a C-obstacle. The subdivision may also end when a predetermined limit on cell subdivision is achieved. The boundary lines 1706 create a number of cells that are trapezoidal. By extending boundary lines 1706 from vertices of the C-obstacle, the resulting free cells are ensured to be convex trapezoids.

Referring again to FIG. 15, cells are defined during cell decomposition at block 1510. Cells (e.g. cells 1708A-K of FIG. 17) are assigned a cell identification (ID). A cell adjacency list is also derived. The cell adjacency list identifies cells that are adjacent via a list of pairwise cell IDs. Two cells are adjacent, for example, when the cells share a boundary line 1706. For example, with respect to FIG. 17A, cells 1708A and 1708B are adjacent, as they share boundary line 1706A1. Additionally, cells 1708A and 1708C are adjacent, as they share boundary line 1706A2.

At block 1512, vertices of interest are inserted into each C-slice. For each C-slice corresponding to a particular pose of the vehicle, a vertex of interest is inserted at each boundary line 1706. Each vertex is identified by a vertex ID and a cell ID location. Referring again to FIG. 17A, vertices of interest 1710 are inserted at the midpoint of each boundary line 1706, where the midpoint is measured from the C-obstacle vertex to the border of the C-slice. In embodiments, the vertices of interest are inserted at a midpoint of a corresponding boundary line. FIG. 17A includes a number of vertices of interest 1710, each illustrated as a black dot on a boundary line 1706. Since the free space trapezoidal cells are convex polygons, a straight line that connects a vertex of interest along one boundary line to a vertex of interest of another boundary line (e.g., boundary lines 1706A1, 1706D1, 1706E1, and 1706H1) is a collision free path through the cell when the cells are adjacent.

At block 1512, a list of adjacent vertices of interest is generated. A first vertex of interest is adjacent to a second vertex of interest if they are located on boundary lines 1706 that have a cell in common. For example, vertex of interest 1710A is adjacent to vertex 1710C, as each of the boundary lines 1706A1 and 1706B border cell 1708B. Vertex of interest 1710A is adjacent to vertex 1710B, as each of the boundary lines 1706A1 and 1706B are collinear and connected by C-obstacle vertex 1702A. A list of adjacent vertices of interest is a pairwise list of vertex identification (IDs).

In FIG. 17A, the selection of vertices of interest is according to the midpoint of each boundary line 1706 as described above. Selecting the midpoint of each cell boundary line as a vertex is typically sufficient to cover all free space in the C-space. Selecting the midpoint of the boundary lines for vertices of interest also reduces the number of vertices needed to cover the free space of a C-space. Redundant vertices that cover approximately the same space as the midpoint vertices are eliminated.

In embodiments, the selection of a location for a vertex of interest is adaptive based on a type of C-obstacle nearest to the boundary line. For example, consider a scenario where the C-obstacle corresponds to a pedestrian. Rather than selecting a midpoint of the boundary line generated from the pedestrian C-obstacle as the location for vertex insertion, the vertex of interest is placed even further away from the pedestrian. For example, the vertex of interest is inserted at 75% of the distance from the C-obstacle vertex to the end of the boundary line. Thus, the present techniques are not obstacle agnostic and can evaluate the type of object when establishing vertices of interest.

FIG. 17B is an illustration of adaptive insertion of vertices of interest. In adaptive insertion, vertices of interest are generated to create paths with difference clearance strategies such that a path can be closer to one type of object (such as a sedan) while further away from another type of object (huge truck, pedestrian). For example, the C-obstacle 1722 represents a vehicle. When the C-obstacle is a vehicle, vertices of interest may be inserted closer to the C-obstacle. In the example of FIG. 17B, the C-obstacle 1724 represents a pedestrian. For a pedestrian, vertex insertion is located farther away from the C-obstacle to provide a greater amount of space when planning a path near the pedestrian. Accordingly, vertices of interest 1720A, 1720B, 1720C, 1720D, 1720E, and 1720F are closer to C-obstacle 1722 when compared to vertices of interest 1720G, 1720H, 1720I, 1720J, 1720K, and 1720L near C-obstacle 1724. Accordingly, the inserted vertices are not required to be uniformly spaced. In an embodiment, the insertion of vertices is adaptive based on the type of detected object on which the C-obstacle is based.

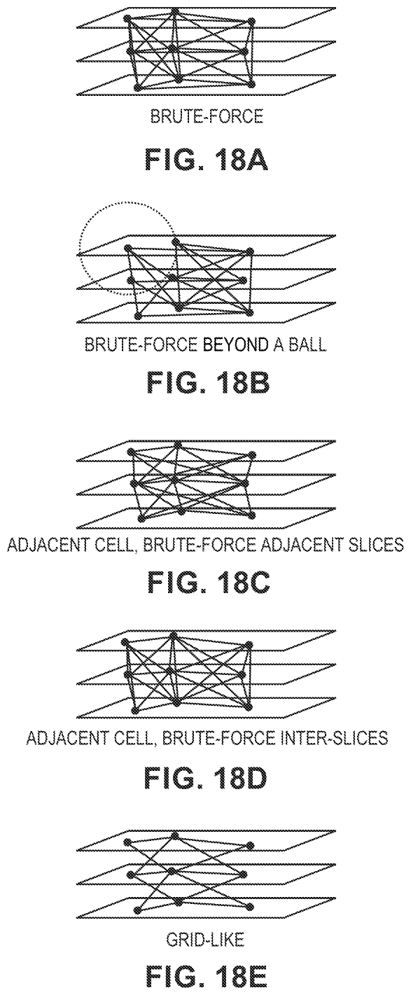

Referring again to FIG. 15, at block 1514 vertices of interest are connected by transitions across adjacent cells to form an adjacency graph for each C-slice. The identification of valid Dubins paths in the list of adjacent vertices in view of a connection strategy can transform the list of adjacent vertices to an adjacency graph for the C-slice as described with respect to FIGS. 18A-18E. The adjacency list provides information on which vertices of interest are adjacent to other vertices of interest on a current C-slice. In an embodiment, the adjacency list is based on whether the cells are connected (adjacent) to each other. The adjacency list for each C-slice is further pruned by determining whether two adjacent vertices can be connected by a valid Dubins path without collision. A Dubins path is the shortest curve that connects two points in a two-dimensional Euclidean plane (X-Y plane). A Dubins path has a constraint on the curvature of the path and the prescribed initial and terminal tangents to the path. Further, there is an assumption that the vehicle traveling the path only travels forward. To perform the collision checking, a set of vehicle poses is calculated by discretizing the Dubins path, and then for each pose, a traditional convex polygon intersection algorithm is used to determine if the vehicle collides (intersects) with any of the C-obstacles. Generally, discretizing the Dubins path creates a polygonal path based on the curvature constrained Dubins path. The discretized Dubins path is subject to turn constraints and length constraints. When connecting vertices of interest according to a connection strategy as described herein, the connections are valid Dubins paths as detected at block 1514. By adding only valid Dubins paths, the present techniques consider the kinematics of the vehicle when generating an adjacency graph via vertex connection. Note that all calculations described with respect to block 1514 FIG. 15 are applied a current C-slice, and vertices of interest for each C-slice are generated independently of other C-slices. The vertices of interest are connected by valid Dubins paths to form an adjacency graph for each C-slice.

If there are additional C-slices left for decomposition and adjacency graph determination, process flow returns to block 1504. If all C-slices have been decomposed and a C-slice adjacency list generated, process flow continues to block 1516. At block 1516, vertices of interest are connected across all C-slices. For example, the C-slice adjacency lists are combined to generate a super adjacency list for the C-slice. The identification of valid Dubins paths in the super adjacency list in view of a connection strategy can transform the super adjacency list to a super adjacency graph for the C-space as described with respect to FIGS. 18A-18E. The connections across C-slices that are not valid Dubins paths are removed from the super adjacency graph.

The process flow diagram of FIG. 15 is not intended to indicate that the blocks of the example process 1500 are to be executed in any order, or that all of the blocks are to be included in every case. Further, any number of additional blocks not shown may be included within the example process 1500, depending on the details of the specific implementation. In some examples, the vertex connections may include adaptive vertex connection, such that insertion locations for the vertices are dependent on the type of C-obstacle, the location of the C-obstacle with respect to other C-obstacles, and the like.

The block diagrams of FIGS. 16, 17A, and 17B are not intended to indicate that the C-slices of FIGS. 16, 17A, and 17B are to include all of the components shown in FIGS. 16, 17A, and 17B. Rather, the C-slices can include fewer or additional components not illustrated in FIGS. 16, 17A, and 17B (e.g., additional C-slices, C-obstacles, vertices of interest, boundary lines, etc.). The C-space 1600, C-slice 1700A, and C-slice 1700B may include any number of additional components not shown, depending on the details of the specific implementation. Furthermore, any of the cell decomposition, adjacency list generation, cell ID generation, vertex ID generation, graph generation and other described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

### Graph Generation and Search

Referring again to FIG. 17A and FIG. 17B, illustrations of C-slices 1700A and 1700B are provided. For example, the C-slices 1700A and 1700B are a C-slice 1602 from FIG. 16. As discussed above, for each C-slice, C-obstacles are represented by a convex polygon. For each C-slice cell decomposition is performed and an adjacency list is generated for each C-slice. In a similar manner, a super adjacency list for vertices of interest across for C-slices is generated. The generation of a super adjacency graph based on the super adjacency list slices is according to the connection strategies described with respect to FIGS. 18A-18E. The connection strategies are based on, at least in part, the location of a first C-slice with respect to other C-slices within the C-space.

A C-slice is adjacent to another C-slice when the C-slices are adjacent in a list of sequential heading values for the C-slices. For example, consider a C-space with six C-slices that sample the environment every 30°. A first C-slice samples at a heading of 0°, a second C-slice samples at a heading of 30°, a third C-slice samples at a heading of 60°, a fourth C-slice samples at a heading of 90°, a fifth C-slice samples at a heading of 120°, and a sixth C-slice samples at a heading of 150°. In this example, the second C-slice is adjacent to the first C-slice and the third C-slice. Connection strategies vary how vertices of interest are connected within each C-slice, and how vertices of interest are connected across C-slices. The connection of vertices of interest across C-slices results in a super adjacency graph for the entire C-space. As described with respect to FIG. 15, the available connections within each C-slice and across C-slices will be those for which a valid Dubins path exists. In an embodiment, the resulting adjacency graph for the C-space is augmented by computing the cost for each edge that connects two adjacent poses.

FIGS. 18A-18E are illustrations of connectivity strategies. FIG. 18A is an illustration of super adjacency graph 1800A using a brute force connection strategy. In a brute force connection strategy, vertices of interest in a first C-slice are connected to all vertices of interest in the first C-slice and in other C-slices. The computational complexity for generating the super adjacency graph 1800A using the brute force connection strategy is O(m²n²), where m is the number of C-slices and n is the number of vertices of interest within each C-slice. The brute force connection strategy creates a complete super adjacency graph 1800A that includes all possible paths in the C-space. A planning system of the vehicle can select a best, most convenient path using the super adjacency graph 1800 as all possible paths are available.

FIG. 18B is an illustration of super adjacency graph 1800B using a brute force beyond a ball connection strategy. Generally, connections using a Dubins path within a certain radius (e.g., ball) from a vertex could violate the minimum turning radius of the vehicle, which can be eliminated automatically without attempting to make the connections. Therefore, to enforce connections beyond a ball region around a graph vertex makes graph connections faster since some infeasible graph edges are not attempted to connect at all.

In the brute force beyond a ball connection strategy, vertices of interest in a first C-slice are connected to all vertices of interest in the first C-slice and in other C-slices, within a predetermined distance from the respective vertex of interest. For example, a first vertex of interest connects only to other vertices of interest within a particular range, such as those within a predetermined radius within the C-space. The radius is used to filter out the vertices of interest that are too far away from a current vertex of interest. The computational complexity is dependent on the radius of the sphere. The computational complexity for generating the super adjacency graph 1800B using the brute force beyond a ball connection strategy approaches O(m²n²) as the radius increases.

FIG. 18C is an illustration of a super adjacency graph 1800C using an adjacent cell, brute force adjacent slices connection strategy. Recall that each C-slice has a number of cells that are generated during cell decomposition. In the adjacent cell, brute force adjacent slices connection strategy, vertices of interest in a first C-slice are connected to all vertices of interest in adjacent cells of the first C-slice. Across C-slices, each vertex of interest is connected to all vertices of interest in adjacent C-slices. For the adjacent cell, brute force adjacent slices connection strategy, the computational complexity is O(mn²). By limiting the connection strategy across C-slices to only those adjacent C-slices, the number of possible C-slices available for connection is reduced. This results in a reduction in computational complexity.

FIG. 18D is an illustration of a super adjacency graph 1800D using an adjacent cell, brute force inter-slice connection strategy. The adjacent cell, brute force inter-slice connection strategy connects vertices of interest in a first C-slice with vertices of interest at adjacent cells of the first C-slice. Across C-slices, each vertex of interest is connected to all vertices of interest in all other C-slices. For the adjacent cell, brute force inter-slice connection strategy, the computational complexity is O(m²n²).

FIG. 18E is an illustration of a super adjacency graph 1800E using a grid-like connection strategy. In the grid-like connection strategy, vertices of interest in a first C-slice are connected to all vertices of interest in adjacent cells of the first C-slice. Across C-slices, each vertex of interest is connected to all vertices of interest in adjacent C-slices. For each vertex, connections are made between the vertices within the adjacent cells from the adjacent C-slice (no attempt connections across multiple cells). For grid-like adjacency, the computation time is O(mn).

The block diagrams of FIGS. 18A-18E are not intended to indicate that the super adjacency graphs of FIGS. 18A-18E are to include all of the components shown in FIGS. 18A-18E. Rather, the graphs can include fewer or additional components not illustrated in FIGs. FIGS. 18A-18E (e.g., additional C-slices, C-slices at differing resolutions, adaptive vertex insertion, vertices of interest, edges, etc.). The super adjacency graphs may include any number of additional components not shown, depending on the details of the specific implementation. Furthermore, any of the connection strategies may be partially, or entirely, implemented in hardware and/or in a processor. For example, the functionality may be implemented with an application specific integrated circuit, in logic implemented in a processor, in logic implemented in a specialized graphics processing unit, or in any other device.

The connection strategies described with respect to FIGS. 18A-18E selectively reduce the number of edges within the C-slice adjacency graphs and the C-space super adjacency graph. This reduction ultimately reduces the amount of collision avoidance computations performed by a planning system (e.g., planning system 404 of FIG. 4) when planning a path. In an embodiment, a graph search is performed to identify a path using the super adjacency graph.

During a graph search, a k-nearest neighbor algorithm is executed to obtain a set of start vertices and a set of end vertices in the super adjacency graph that are closest to the start and end poses of the vehicle. In some cases the actual start and end pose of the vehicle do not completely line up with vertices of the generated C-space. Invalid start and end vertices are filtered out by determining if a valid Dubins path exists that can connect the start vertices and the end vertices. Given all combinations of valid start and end vertices, the shortest path between each start vertex and an end vertex pair is calculated using a shortest path algorithm. The path with the smallest total cost is selected as the optimal path through the space. In an embodiment, Dijkstra's algorithm is executed to find the shortest path in the graph for each pair of start and end vertices. In an embodiment, the shortest path algorithm is an A* algorithm. For ease of description, paths are described as being selected according to a lowest cost. However, a most optimal path can be selected based on time, environment, or any other factors.

### Collision Free Path Generation by Connecting C-Slices Through Cell Decomposition

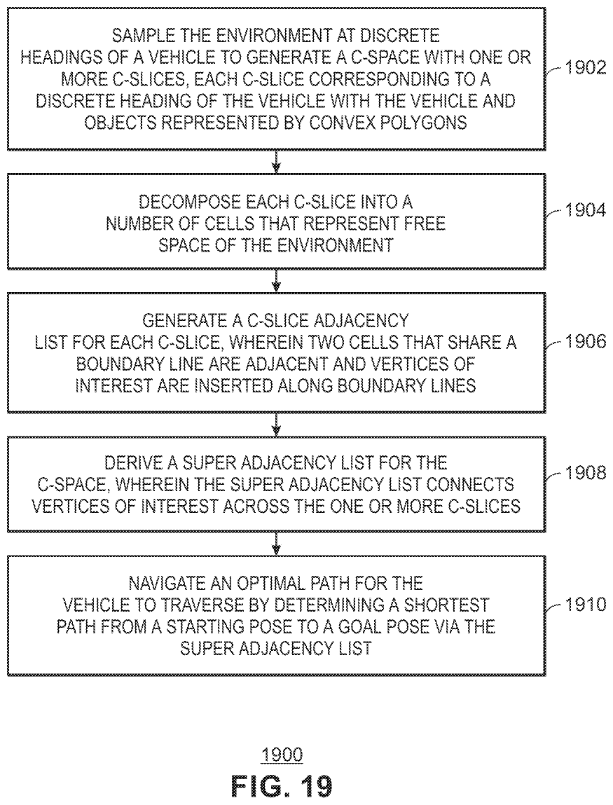

FIG. 19 a process flow diagram of a process 1900 that enables fast collision free path generation by connecting C-slices through cell decomposition. In the example of FIG. 19, Dubins paths are determined and used to connect the critical points between C-slices.

At block 1902, the environment (e.g., environment 190) is sampled at discrete headings of a vehicle to generate a configuration space (C-space) with one or more C-slices, each C-slice corresponding to a discrete heading of the vehicle. In an embodiment, the environment is sampled using a perception system (e.g., perception system 402 of FIG. 4). Discrete headings enable the use of Minkowski sums to represent the vehicle and objects as convex polygons.

At block 1904, cell decomposition is performed at the one or more C-slices. Cell decomposition decomposes each C-slice into a number of cells that represent areas of the environment where no objects are detected.

At block 1906, a C-slice adjacency list is generated. The C-slice adjacency list is a list of vertices of interest for each C-slice and adjacency information associated with each vertex of interest. Two cells that share a boundary line are adjacent, and vertices of interest are inserted along boundary lines. In an embodiment, vertices of interest are inserted at the mid-point of each cell boundary line. In an embodiment, vertices of interest are located adaptively by selecting a vertex location on the cell boundary based on a type of nearby C-obstacle.

At block 1908, a super adjacency list of vertices of interest is derived for the C-space. The super adjacency list and the adjacency lists are used to connect vertices of interest with one or more edges to form a super adjacency graph. Strategies for connections of vertices of interest across the one or more C-slices include, for example, cell based brute-force (e.g., FIG. 18A), brute-force beyond a ball (e.g., FIG. 18B), cell-based, adjacent cell and brute-force for inter-cell connections (e.g., FIG. 18C), cell-based, adjacent cell and brute-force for adjacent cell connections (e.g., FIG. 18D), or cell-based, grid-like (e.g., FIG. 18E).

At block 1910, an optimal path for the vehicle to traverse is navigated by determining a shortest path from a starting pose to a goal pose via the super adjacency graph.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method comprising:
sampling, by a perception circuit, an environment at discrete headings of a vehicle to generate a configuration space (C-space) with one or more C-slices, wherein a first C-slice corresponds to a discrete heading of the vehicle, and the vehicle and detected objects are represented by convex polygons;
decomposing, by a processor, the first C-slice into one or more cells that represent free space;
generating, by the processor, a C-slice adjacency list for the first C-slice, wherein two cells that share a boundary line are adjacent and vertices of interest are inserted along boundary lines;
deriving, by the processor, a super adjacency list for the C-space, wherein the super adjacency list connects vertices of interest across the one or more C-slices to form a super adjacency graph based on, at least in part, a Dubins path; and
navigating, by a planning circuit, an optimal path, wherein the optimal path is a shortest path from a starting pose to a goal pose on the super adjacency graph.

2. The method of claim 1, wherein the discrete headings are predetermined.

3. The method of claim 1, wherein decomposing the first C-slice into a number of cells comprises:
calculating a Minkowski sum between a convex polygon of the vehicle and a convex polygon of the detected objects to obtain C-obstacle vertices, wherein a detected object corresponds to a C-obstacle; and
inserting a boundary line with a first point at a C-obstacle vertex and extending the boundary line to a second point, wherein the second point is located at another C-obstacle, a border of the first C-slice, or any combinations thereof.

4. The method of claim 1, wherein a vertex of interest is inserted at a midpoint of a corresponding boundary line.

5. The method of claim 1, wherein the vertices of interest are adaptively inserted based on, at least in part, a C-obstacle type.

6. The method of claim 1, wherein the super adjacency graph is derived by connecting the vertices of interest in the first C-slice with all remaining vertices of interest in other C-slices of the one or more of C-slices.

7. The method of claim 1, wherein the super adjacency graph is derived by, for each vertex of interest in the first C-slice, connecting a respective vertex of interest of the first C-slice with the vertices of interest in other C-slices that are within a predetermined distance from the respective vertex of interest.

8. The method of claim 1, wherein the super adjacency graph is derived by, for each vertex of interest in the first C-slice, connecting the vertices of interest in the first C-slice to the vertices of interest in adjacent cells of the first C-slice and connecting the vertices of interest in the first C-slice to the vertices of interest in adjacent C-slices.

9. The method of claim 1, wherein the super adjacency graph is derived by connecting the vertices of interest in the first C-slice with the vertices of interest in adjacent cells of the first C-slice and connecting the vertices of interest in the first C-slice to the vertices of interest in the one or more C-slices.

10. The method of claim 1, wherein the super adjacency graph is derived by, for each vertex of interest in the first C-slice, connecting a respective vertex of interest to other vertices of interest in other C-slices to form a grid.

11. A non-transitory computer-readable storage medium comprising at least one program for execution by at least one processor of a first device, the at least one program including instructions which, when executed by the at least one processor, carry out a method comprising:
sampling an environment at discrete headings of a vehicle to generate a configuration space (C-space) with one or more C-slices, wherein a first C-slice corresponds to a discrete heading of the vehicle, and the vehicle and detected objects are represented by convex polygons;
decomposing the first C-slice into one or more of cells that represent free space;
generating a C-slice adjacency list for the first C-slice, wherein two cells that share a boundary line are adjacent and vertices of interest are inserted along boundary lines;
deriving a super adjacency list for the C-space, wherein the super adjacency list connects vertices of interest across the one or more C-slices to form a super adjacency graph based on, at least in part, a Dubins path; and
navigating an optimal path, wherein the optimal path is a shortest path from a starting pose to a goal pose on the super adjacency graph.

12. The computer-readable storage medium of claim 11, wherein decomposing the first C-slice into a number of cells comprises:
calculating a Minkowski sum between a convex polygon of the vehicle and a convex polygon of the detected objects to obtain C-obstacle vertices, wherein a detected object corresponds to a C-obstacle; and
inserting a boundary line with a first point at a C-obstacle vertex and extending the boundary line to a second point, wherein the second point is located at another C-obstacle, a border of the first C-slice, or any combination thereof.

13. A vehicle, comprising:
at least one sensor configured to detect poses and geometric shapes of objects in an environment, wherein a start pose and an end pose of the vehicle is specified;
at least one computer-readable medium storing computer-executable instructions;
at least one processor communicatively coupled to the at least one sensor and configured to execute the computer executable instructions, the execution carrying out operations including:
sampling the environment at discrete headings of the vehicle to generate a configuration space (C-space) with one or more C-slices, wherein a first C-slice corresponds to a discrete heading of the vehicle, and wherein the vehicle and the objects are represented by convex polygons;
decomposing the first C-slice into one or more cells that represent free space;
generating a C-slice adjacency list for the first C-slice, wherein two cells that share a boundary line are adjacent and vertices of interest are inserted along boundary lines;
deriving a super adjacency list for the C-space, wherein the super adjacency list connects vertices of interest across the one or more C-slices to form a super adjacency graph based on at least in part, a Dubins path; and
a control circuit communicatively coupled to the at least one processor, wherein the control circuit is configured to operate the vehicle from the start pose to the end pose based on the super adjacency graph.

14. The vehicle of claim 13, wherein the operations comprise:
calculating a Minkowski sum between a convex polygon of vehicle and a convex polygon the objects obtain C-obstacle vertices, wherein an object corresponds to a C-obstacle; and
inserting a boundary line with a first point at a C-obstacle vertex and extending the boundary line to a second point, wherein the second point is located at another C-obstacle, a border of the first C-slice, or any combinations thereof.

15. The vehicle of claim 1, wherein the operations comprise inserting a vertex of interest at a midpoint of a corresponding boundary line.

16. The vehicle of claim 1, wherein the operations comprise adaptively inserting the vertices of interest based on, at least in part, a C-obstacle type.

17. The vehicle of claim 1, wherein the operations comprise deriving the super adjacency graph by connecting the vertices of interest in the first C-slice with all remaining vertices of interest in other C-slices of the one or more of C-slices.

18. The vehicle of claim 1, wherein the operations comprise deriving the super adjacency graph by, for each vertex of interest in the first C-slice, connecting a respective vertex of interest of the first C-slice with vertices of interest in other C-slices that are within a predetermined distance from the respective vertex of interest.

19. The vehicle of claim 1, wherein the operations comprise deriving the super adjacency graph by, for each vertex of interest in the first C-slice, connecting the vertices of interest in the first C-slice to the vertices of interest in adjacent cells of the first C-slice and connecting each vertex of interest in the first C-slice to the vertices of interest in adjacent C-slices.

20. The vehicle of claim 1, wherein the operations comprise deriving the super adjacency graph by, for each vertex of interest in the first C-slice, connecting vertices of interest in the first C-slice with the vertices of interest in adjacent cells of the first C-slice and connecting the vertices of interest in the first C-slice to the vertices of interest in each of the one or more C-slices.

21. The vehicle of claim 1, wherein the operations comprise deriving the super adjacency graph by, for each vertex of interest in the first C-slice, connecting a respective vertex of interest to other vertices of interest in other C-slices to form a grid.
